(19) United States
(12) Patent Application Publication
(10) Pub. No.: US 2005/0028657 A1
(43) Pub. Date: Feb. 10, 2005

(54) Tunable cutting device

(76) Inventors: Richard John Mitro, San Ramon, CA (US); Robert Nathan Edwards, Fremont, CA (US)

Correspondence Address: DINSMORE & SHOHL LLP;One Dayton Centre, Suite 500, One South Main Street, Dayton, OH, 45402-2023, US

(21) Appl. No.: 10/824,195

(22) Filed: Apr. 14, 2004

Related U.S. Application Data
(60) Provisional application No. 60/492,411, filed on Aug. 4, 2003.

(51) Int. Cl. B23B 3/00

(52) U.S. Cl. 82/118; 82/904; 409/289

(57) ABSTRACT

A tunable cutting device is provided including a drive unit configured to oscillate the cutting tool and an oscillation frequency control configured to permit variation of an oscillation frequency of the drive unit as the cutting tool oscillates along the cutting axis. According to a method of operating a tunable cutting device, the oscillation frequency of the drive unit is controlled as the cutting tool oscillates along the cutting axis during the object cutting operation.

### CROSS-REFERENCE TO RELATED APPLICATIONS

This application claims the benefit of U.S. Provisional Application Ser. No. 60/492,411, filed Aug. 4, 2003.

### BACKGROUND OF THE INVENTION

The present invention relates to oscillating cutting devices and, more particularly, to operational and design improvements to such devices.

### BRIEF SUMMARY OF THE INVENTION

According to the present invention, a tunable cutting device is provided. In accordance with one embodiment of the present invention, a tunable cutting device is provided comprising a drive unit configured to oscillate the cutting tool and an oscillation frequency control configured to permit variation of an oscillation frequency of the drive unit as the cutting tool oscillates along the cutting axis.

In accordance with another embodiment of the present invention, a method of operating a tunable cutting device is provided. According to the method oscillation of a drive unit configured to oscillate the cutting tool is initiated, the oscillating cutting tool is engaged with the object to initiate an object cutting operation, and the oscillation frequency of the drive unit is controlled as the cutting tool oscillates along the cutting axis during the object cutting operation.

Accordingly, it is an object of the present invention to provide a tunable cutting device embodying particular operational and design improvements. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of a tunable cutting device according to one embodiment of the present invention;

FIG. 2 is an illustration of a cutting tool progressing through an object to be cut according to one embodiment of the present invention; and

FIG. 3 is a schematic illustration of a voltage controlled oscillator circuit suitable for use in accordance with the present invention.

### DETAILED DESCRIPTION

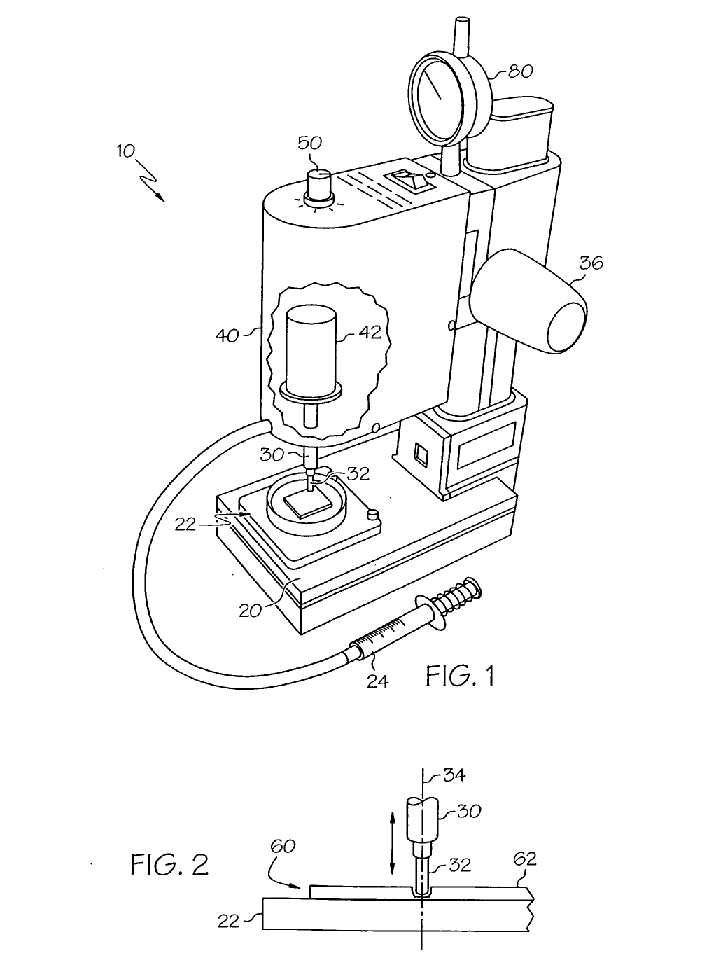

Referring initially to FIGS. 1 and 2, a tunable cutting device 10 according to one embodiment of the present invention is illustrated. The cutting device 10 comprises an object support platform 20, a cutting tool mount 30, a cutting tool 32 secured to the cutting tool mount 30, a drive unit 40, and an oscillation frequency control 50.

The object support platform 20 defines an object position 60 and the drive unit 40, which includes a suitable drive element 42, is configured to oscillate the cutting tool 32 along a cutting axis 34 intersecting the object position 60. It is contemplated that the drive unit 40 may comprise a piezoelectric drive element, a magnetostrictive drive element, an electromagnetic drive element, or any other suitable drive element capable of imparting controlled oscillation to the cutting tool. The oscillation frequency control 50 is configured to permit variation of the oscillation frequency of the drive unit 40 as the cutting tool 32 oscillates along the cutting axis 34, as is generally indicated by the directional arrow in FIG. 2.

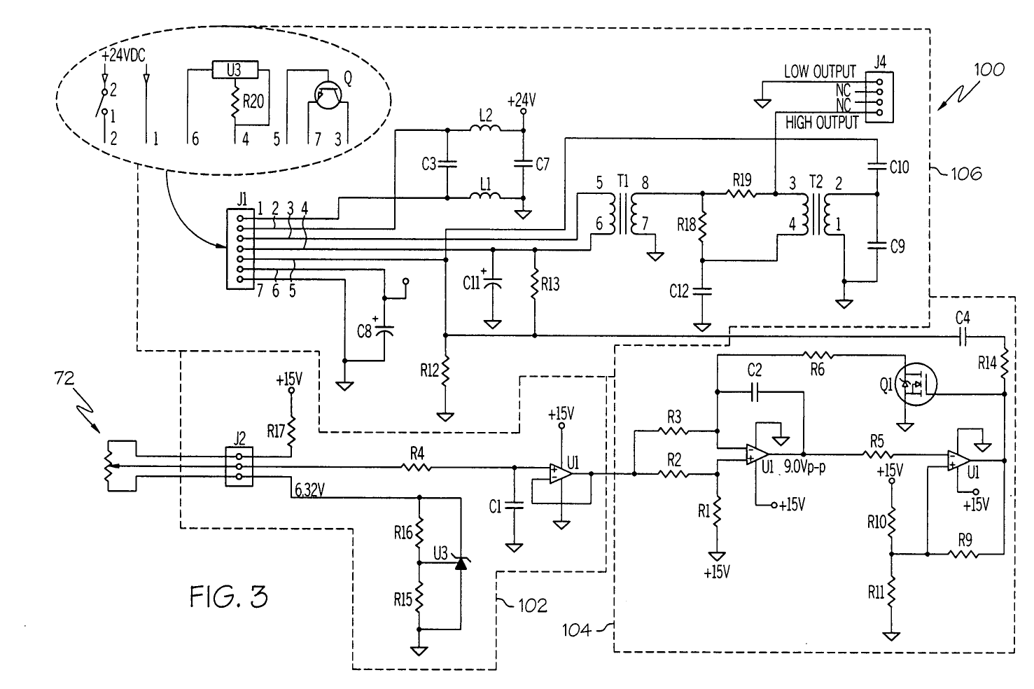

The tunable cutting device 10 may be configured to indicate the rate at which the cutting tool 32 moves along the cutting axis through a thickness dimension of an object 62 in the object position 60. In this manner, the oscillation frequency control 50 may be configured to permit simultaneous observation of the cutting rate and variation of the oscillation frequency as a function of the cutting rate. In the illustrated embodiment, the oscillation frequency is varied manually by controlling the position of a potentiometer 72 (see FIG. 3) that is accessible via the externally mounted frequency control 50. However, it is contemplated that manual control may be affected by other suitable means. It is also contemplated that control of the oscillation frequency may be automated, particularly where the oscillation frequency is to be controlled as a function of an observed cutting rate.

The cutting rate may be observed visually with the use of, for example, a cutting depth indicator 80 configured to indicate a position of the cutting tool 32 along the cutting axis 34. As will be appreciated by those practicing such an aspect of the present invention, the rate at which the cutting depth varies will be directly proportional to the cutting rate and the oscillation frequency may be controlled to optimize the cutting rate. It is contemplated that any other suitable means of visually observing the cutting rate may be employed without departing from the scope of the present invention.

A cutting rate indication may also be gleaned from an audible observation. For example, according to one aspect of the present invention, the frequency or intensity of the audible signal generated by the contact of the cutting tool 32 with an object 62 in the object position 60 may be taken as an indication of cutting rate. It is further contemplated that an automated process involving a direct or indirect observation of the cutting rate may also be employed according to the present invention. In any case, the oscillation frequency control 50 may be configured to permit variation of the oscillation frequency as a function of the cutting rate.

Although a variety of suitable oscillation frequencies are contemplated according to the present invention, in one embodiment, the oscillation frequency control 50 permits variation of the oscillation frequency from about 18 kHz to about 1000 kHz. More prefereably, the oscillation frequency control is configured to permit variation of the oscillation frequency from about 20 kHz to about 41 kHz. In a specific embodiment of the present invention, the piezoelectric drive unit is configured to oscillate the cutting tool 32 along the cutting axis 34 at about 26 kHz. In terms of frequency range, it is contemplated that variation of the oscillation frequency may be permitted over a range of at least about 20 kHz. The precision of the oscillation frequency control 50 will vary according to the needs associated with the particular application of the present invention. For example, in some embodiments of the present invention, the oscillation frequency control is configured to permit variation of the oscillation frequency at increments of less than about 0.2 kHz.

According to one aspect of the present invention, the oscillation frequency control is configured to permit variation of the oscillation frequency across a frequency range including the resonant frequency of the cutting tool 32. In this manner, the effectiveness of the cutting operation may be optimized. By way of illustration and not limitation, it is contemplated that the cutting tool may comprise one of a circular cutting tool, a rectangular cutting tool, a square cutting tool, a triangular cutting tool, and combinations thereof. The cutting tool mount 30 is preferably configured to permit convenient removal and replacement of the cutting tool 32. A cutting height controller 36 may be provided to enable adjustment of the position of the cutting tool along the cutting axis 34. The cutting axis 34 is typically oriented perpendicular to the object support platform 20.

The object support platform 20 and the drive unit 40 may be configured such that the cutting tool 32 and the object 62 are urged towards each other along the cutting tool axis 34 as the cutting tool oscillates. Although there are a variety of suitable ways to accomplish such a relationship, according to one aspect of the present invention, the object support platform 20 comprises a spring loaded, hinged platform forcibly biased in the direction of the cutting tool 32 along the cutting axis 34. To help secure the object 62, the object support platform 20 may comprise a magnetic base. Further, the object table 22 may be configured to contain an abrasive cutting slurry about the object 62. Further to this end, the cutting device 10 may further comprise a cutting slurry supply 24.

Frequency tuning may be accomplished by providing a voltage-controlled oscillator (VCO). The output of the oscillator controls the oscillations of the power stage electronics of the drive unit 40. FIG. 3 is circuit schematic illustrating an example of suitable electronic circuitry of a VCO although a variety of additional circuits will also be suitable for use with the present invention. More specifically, the circuitry 100 includes a control voltage input section 102 for generating the control voltage for the VCO, a voltage controlled oscillator stage 104, and a power driver section 106.

Where an externally accessible potentiometer 72 is incorporated as the control element of the oscillation frequency control 50, the three terminals of the potentiometer are connected to the connector J2 of the control voltage input section 102. The resistors R15, R16, R17 and the diode U3 determine the voltage range of the potentiometer. This voltage appears at the output of the operational amplifier U1. By way of illustration and not limitation, the components in the control voltage input section 102 may be identified as follows: R4, 1 kΩ; R15, 1.74 kΩ; R16, 2.67 kΩ; R17, 215 Ω; and C1, 0.1 F.

In the voltage controlled oscillator stage 104, the control voltage is applied to the resistors R2, R3. The two operational amplifiers U1 and associated components form a feedback oscillator system that generates a square wave of constant duty-cycle. The frequency of the square wave is proportional to the control voltage. The square wave goes to the power driver section of the circuitry through the resistor R14 and the capacitor C4. By way of illustration and not limitation, the components in the voltage controlled oscillator stage 104 may be identified as follows: R1, R2, R3, 4.02 kΩ; R5, R6, 2.0 kΩ; R9, R14, 3.32 kΩ; R10, R11, 10 kΩ; C2, 0.0022 μF; C4, 0.1 μF; and Q1, n-channel enhancement mode field effect transistor.

In the power driver section 106, the drive element 42 of the drive unit 40 is connected to connector J4. The main drive transistor Q, current limiter U3, and +24V power supply are external components that connect to J1. The drive transistor connects to J1 pins 3, 5, 7. The base drive comes into J1 at pin 5 from the voltage controlled oscillator stage 104. The collector output connects to the first stage of the transformer T1 at pins 5, 6. The first stage of the transformer T1 (pins 5, 6, 7, 8) steps-up the voltage to the piezo drive element 42 of the drive unit 40. The second stage (pins 1, 2, 3, 4) forms an L-C resonance with the capacitance of the piezo element. By way of illustration and not limitation, the components in the power driver section 106 may be identified as follows: R12, 10 kΩ; R13 15 kΩ; R18, 150 Ω, 5 W; R19, 100 Ω, 5 W; R20, 2Ω, 3 W; C3, C7, 0.1 μF; C8, 100 F, 63V; C9, 0.015 μF, 50V; C10, 0.02 μF, 100V; C11, 1000 μF, 35V; C12, 0.001 μF, 400V; L1, L2, 10 MHz, 2.5 T; T1, 6 mH/13 mH; T2, 1.6 mH/10 mH; and U3, voltage regulator.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A tunable cutting device comprising:
an object support platform defining an object position;
a cutting tool mount;
a cutting tool secured to said cutting tool mount;
a drive unit configured to oscillate said cutting tool along a cutting axis intersecting said object position; and
an oscillation frequency control configured to permit variation of an oscillation frequency of said drive unit as said cutting tool oscillates along said cutting axis.

2. A tunable cutting device as claimed in claim 1 wherein said tunable cutting device is configured to provide an indication of a cutting rate at which said cutting tool moves along said cutting axis.

3. A tunable cutting device as claimed in claim 2 wherein said oscillation frequency control is configured to permit simultaneous observation of said cutting rate and variation of said oscillation frequency.

4. A tunable cutting device as claimed in claim 3 wherein said variation of said oscillation frequency comprises one of a manual operation, an automated operation, and combinations thereof.

5. A tunable cutting device as claimed in claim 3 wherein said observation of said cutting rate comprises one of a visual observation, an audible observation, an automated observation, and combinations thereof.

6. A tunable cutting device as claimed in claim 2 wherein said oscillation frequency control is configured to permit variation of said oscillation frequency as a function of said cutting rate.

7. A tunable cutting device as claimed in claim 2 wherein said oscillation frequency control is configured to permit variation of said oscillation frequency from about 18 kHz to about 1000 kHz.

8. A tunable cutting device as claimed in claim 2 wherein said oscillation frequency control is configured to permit variation of said oscillation frequency from about 20 kHz to about 41 kHz.

9. A tunable cutting device as claimed in claim 2 wherein said oscillation frequency control is configured to permit variation of said oscillation frequency over a range of at least about 20 kHz.

10. A tunable cutting device as claimed in claim 2 wherein said oscillation frequency control is configured to permit variation of said oscillation frequency at increments of less than about 0.2 kHz.

11. A tunable cutting device as claimed in claim 2 wherein said variation of said oscillation frequency is affected through manual control of a potentiometer.

12. A tunable cutting device as claimed in claim 11 wherein said potentiometer comprises an externally accessible potentiometer.

13. A tunable cutting device as claimed in claim 2 wherein said variation of said oscillation frequency is affected through manual control of said oscillation frequency.

14. A tunable cutting device as claimed in claim 2 wherein said variation of said oscillation frequency is affected through automatic control of said oscillation frequency.

15. A tunable cutting device as claimed in claim 2 wherein said indication of said cutting rate comprises a visual signal.

16. A tunable cutting device as claimed in claim 2 wherein said indication of said cutting rate comprises an audible signal

17. A tunable cutting device as claimed in claim 16 wherein said audible signal is generated from contact of said cutting tool with an object in said object position.

18. A tunable cutting device as claimed in claim 2 wherein said indication of said cutting rate comprises a visual signal and an audible signal.

19. A tunable cutting device as claimed in claim 1 wherein said oscillation frequency control comprises a voltage controlled oscillator.

20. A tunable cutting device as claimed in claim 19 wherein an output of said voltage controlled oscillator is coupled to said drive unit.

21. A tunable cutting device as claimed in claim 19 wherein said voltage controlled oscillator comprises electronic circuitry comprising a control voltage input section, a voltage controlled oscillator stage, and a power driver section.

22. A tunable cutting device as claimed in claim 1 wherein said cutting tool defines a resonant frequency and said oscillation frequency control is configured to permit variation of said oscillation frequency across a frequency range including said resonant frequency of said cutting tool.

23. A tunable cutting device as claimed in claim 1 wherein said cutting tool comprises one of a circular cutting tool, a rectangular cutting tool, a square cutting tool, a triangular cutting tool, and combinations thereof.

24. A tunable cutting device as claimed in claim 1 wherein said cutting tool mount is configured to permit removal and replacement of said cutting tool.

25. A tunable cutting device as claimed in claim 1 wherein said cutting tool further comprises a cutting height controller configured to adjust a position of said cutting tool along said cutting axis.

26. A tunable cutting device as claimed in claim 1 wherein said tunable cutting device comprises a cutting depth indicator configured to indicate a position of said cutting tool along said cutting axis.

27. A tunable cutting device as claimed in claim 26 wherein said cutting depth indicator is further configured to indicate a cutting rate at which said cutting tool moves along said cutting axis.

28. A tunable cutting device as claimed in claim 27 wherein said oscillation frequency control is configured to permit variation of said oscillation frequency as a function of said cutting rate indicated by said cutting depth indicator.

29. A tunable cutting device as claimed in claim 1 wherein said drive unit comprises a piezoelectric drive unit.

30. A tunable cutting device as claimed in claim 1 wherein said drive unit is configured to oscillate said cutting tool along said cutting axis at about 26 kHz.

31. A tunable cutting device as claimed in claim 1 wherein said object support platform defines an object support plane and said cutting axis is oriented substantially perpendicular to said object support plane.

32. A tunable cutting device as claimed in claim 1 wherein said object support platform and said drive unit are configured such that said cutting tool and said object are urged towards each other along said cutting tool axis as said cutting tool oscillates.

33. A tunable cutting device as claimed in claim 1 wherein said object support platform comprises a spring loaded platform.

34. A tunable cutting device as claimed in claim 1 wherein said object support platform comprises a hinged platform.

35. A tunable cutting device as claimed in claim 1 wherein said object support platform comprises a magnetic base.

36. A tunable cutting device as claimed in claim 1 wherein said object support platform comprises an object table configured to accommodate an object to be cut in a cutting slurry.

37. A tunable cutting device as claimed in claim 36 wherein said cutting tool further comprises a cutting slurry supply.

38. A tunable cutting device comprising:
an object support platform defining an object position;
a cutting tool mount;
a cutting tool secured to said cutting tool mount and defining a resonant frequency;
a drive unit configured to oscillate said cutting tool along a cutting axis intersecting said object position at a frequency of between about 20 kHz and about 41 kHz;
an oscillation frequency control configured to permit variation of an oscillation frequency of said drive unit as said cutting tool oscillates along said cutting axis, wherein
said oscillation frequency control comprises a voltage controlled oscillator coupled to said drive unit,
said oscillation frequency control is configured to permit variation of said oscillation frequency across a frequency range including said resonant frequency of said cutting tool,
said variation of said oscillation frequency is permitted over a range of at least about 20 kHz at increments of less than about 0.2 kHz, and
said variation of said oscillation frequency is affected through manual control of an externally accessible potentiometer; and
a cutting depth indicator configured to indicate a position of said cutting tool along said cutting axis, wherein
said cutting depth indicator is further configured to indicate a cutting rate at which said cutting tool moves along said cutting axis,
said oscillation frequency control is configured to permit variation of said oscillation frequency as a function of said cutting rate indicated by said cutting depth indicator,
said oscillation frequency control is configured to permit simultaneous observation of said cutting rate and variation of said oscillation frequency

39. A method of operating a tunable cutting device, said method comprising:
positioning an object on an object support platform of said tunable cutting device so as to define an object position;
securing a cutting tool to a cutting tool mount of said device;
initiating oscillation of a drive unit configured to oscillate said cutting tool along a cutting axis intersecting said object position;
engaging said oscillating cutting tool and said object so as to initiate an object cutting operation;
controlling an oscillation frequency of said drive unit as said cutting tool oscillates along said cutting axis during said object cutting operation.
